(19) United States
(12) Patent Application Publication
(10) Pub. No.: US 2014/0370452 A1
(43) Pub. Date: Dec. 18, 2014

(54) ORTHODONTIC SYSTEM

(71) Applicant: Chen-Wen TSENG, Taipei City (TW)

(72) Inventor: Chen-Wen TSENG, Taipei City (TW)

(21) Appl. No.: 14/302,786

(22) Filed: Jun. 12, 2014

(30) Foreign Application Priority Data
Jun. 13, 2013 (TW) 102120908
Apr. 28, 2014 (TW) 103115156

(51) Int. Cl. A61C 7/08; A61C 7/16; A61C 7/04

(52) U.S. Cl. CPC A61C 7/08; A61C 7/04; A61C 7/16
USPC 433/4; 433/6; 433/214

(57) ABSTRACT

An orthodontic system includes a dental appliance and an auxiliary arrangement unit. The dental appliance includes a main body defining a receiving space for receiving at least a portion of a dentition of a user therein. The main body is formed with a main projection projecting outwardly away from the receiving space. The auxiliary arrangement unit includes an attaching member to be bonded to a tooth of the dentition, and a restraining member interconnecting the main projection and the attaching member for moving the tooth toward the main projection.

### CROSS-REFERENCES TO RELATED APPLICATION

This application claims priority to Taiwanese Application No. 102120908, filed on Jun. 13, 2013 and Taiwanese Application No. 103115156, filed on Apr. 28, 2014.

### BACKGROUND OF THE INVENTION

1. Field of the Invention

The invention relates to an orthodontic system capable of correcting of irregular teeth of a user.

2. Description of the Related Art

Referring to FIG. 1, a first example of conventional dental braces 1 includes a metal wire 12 and a plurality of metal brackets 11 attached respectively to teeth 100 of a user. The metal wire 12 extends through the brackets 11 to align and correct the teeth 100 to desired positions. However, the conventional dental braces 1 have a relatively poor visual aesthetic quality.

FIG. 2 shows another conventional dental braces 2 disclosed in Taiwanese Utility Model No. M441455, which include a plurality of brackets 21 and a metal wire 23 extending through the brackets 21. The brackets 21 are coated with composite materials 22, such as ceramic, having a color similar to that of tooth color. However, the metal wire 23 is still visible, and thus, also adversely affects aesthetic appearance of the user. Additionally, both of the conventional dental braces 1 and 2 are difficult to clean, resulting in dental caries and periodontal diseases.

Referring to FIG. 3A, a conventional dental appliance 300 for receiving a dentition of a user is shown. The conventional dental appliance 300 contacts and pushes a tooth 200 that requires rearrangement in a direction indicated by arrow shown in FIG. 3A. Further referring to FIG. 3B, however, a torque generated by the dental appliance 300 would cause lingual crown tip of the tooth 200 and a root 201 of the tooth 200,and the tooth 200 and the root 201 thereof would be inclined relative to the alveolar buccal bone, resulting in prominence of the root 201.

An object of the present invention is to provide an orthodontic system that has a relatively good visual aesthetic quality and that may prevent prominence of the root.

### SUMMARY OF THE INVENTION

According to the present invention, there is provided an orthodontic system that includes a dental appliance made of a transparent material and an auxiliary arrangement unit. The dental appliance includes a main body that includes a buccal side wall and a lingual side wall opposite to and cooperating with the buccal side wall to define a receiving space for receiving at least a portion of a dentition of a user therein. At least one of the buccal side wall and the lingual side wall define a reserve room in spatial communication with the receiving space for providing flexibility to the main body so as to accommodate movement of the tooth caused by correcting the tooth. The main body is formed with a main projection projecting outwardly away from the receiving space. The auxiliary arrangement unit includes an attaching member that is adapted to be bonded to a tooth of the dentition, and at least one restraining member that interconnects the main projection and the attaching member for moving the tooth in a direction toward the main projection.

### BRIEF DESCRIPTION OF THE DRAWINGS

Other features and advantages of the present invention will become apparent in the following detailed description of the preferred embodiments with reference to the accompanying drawings, of which:

FIG. 1 is a schematic front view of conventional dental braces attached to teeth of a user;

FIG. 2 is a schematic front view of another conventional dental braces including a plurality of brackets that are coated with composite materials having a color similar to tooth color;

FIG. 3A is a schematic cross-sectional view of a conventional dental appliance covering a tooth;

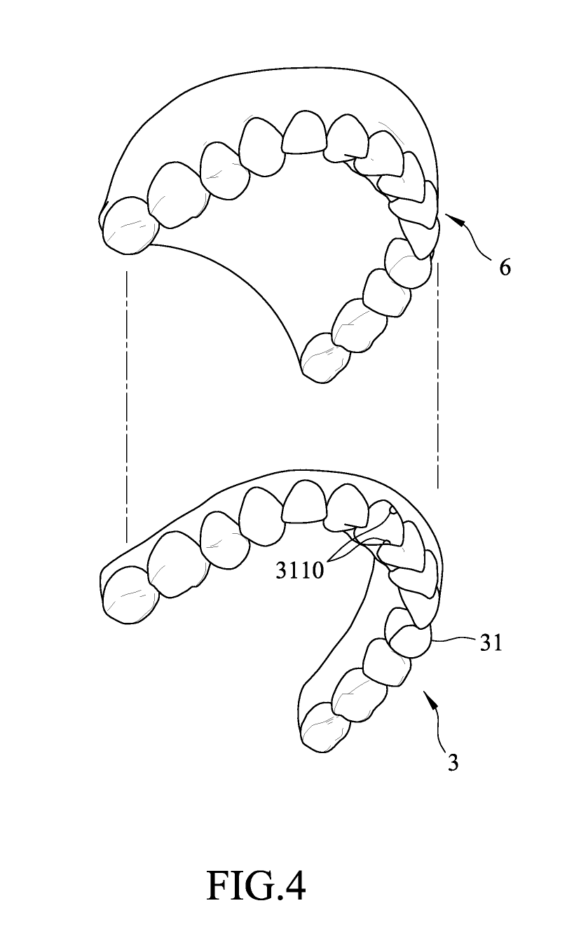

FIG. 3B is a schematic side view of the tooth being pushed and rotated by the conventional dental appliance;

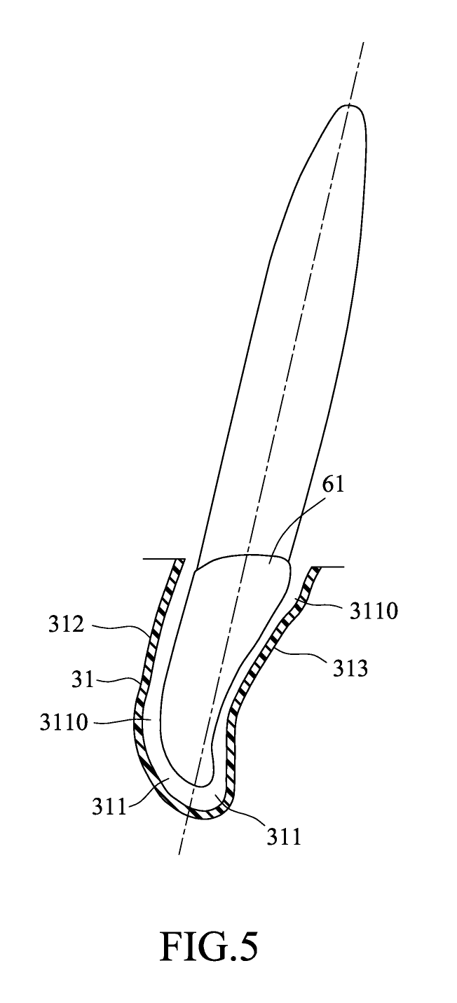

FIG. 4 is a perspective view of a first preferred embodiment of an orthodontic system according to the present invention, illustrating a dental appliance of the orthodontic system and a dentition to be received therein;

FIG. 5 is a schematic cross-sectional view of the dental appliance formed with two protrusions for contacting and pushing a tooth of the dentition;

FIG. 6 is a schematic cross-sectional view of the dental appliance used to pitch the tooth of the dentition;

FIG.7A is a schematic top view of a modification of the dental appliance, illustrating another example of a tooth to be rotated by a torsion force provided by the protrusions;

FIG. 7B is a schematic top view of another modification of the dental appliance, illustrating one protrusion being formed on the dental appliance to provide a push force to a tooth;

FIG. 8 is a perspective view of a pliers for forming a protrusion on the dental appliance of the first preferred embodiment;

FIGS. 9 to 13 are fragmentary perspective views illustrating various configurations of the pliers, respectively;

FIG. 14 is a schematic front view of the dental appliance of the first preferred embodiment, illustrating protrusions having different profiles formed by the pliers shown in FIGS. 8 to 13;

FIG. 15 is a perspective view of a second preferred embodiment of the orthodontic system according to the present invention;

FIG. 16 is a perspective schematic view illustrating the dental appliance of the second preferred embodiment and a dentition to be received therein;

FIG. 17 is a perspective view of an attaching member of an auxiliary arrangement unit of the second preferred embodiment that is to be bonded to a tooth of the dentition;

FIG. 18 is a schematic perspective view of a third preferred embodiment of the orthodontic system according to the present invention;

FIG. 19 is a schematic perspective view of a fourth preferred embodiment of the orthodontic system according to the present invention; and

FIG. 20 is a flow chart illustrating a method of manufacturing the orthodontic system according to the present invention.

### DETAILED DESCRIPTION OF THE PREFERRED EMBODIMENTS

Before the present invention is described in greater detail, it should be noted that like reference numerals are used to indicate corresponding or analogous elements throughout the accompanying disclosure.

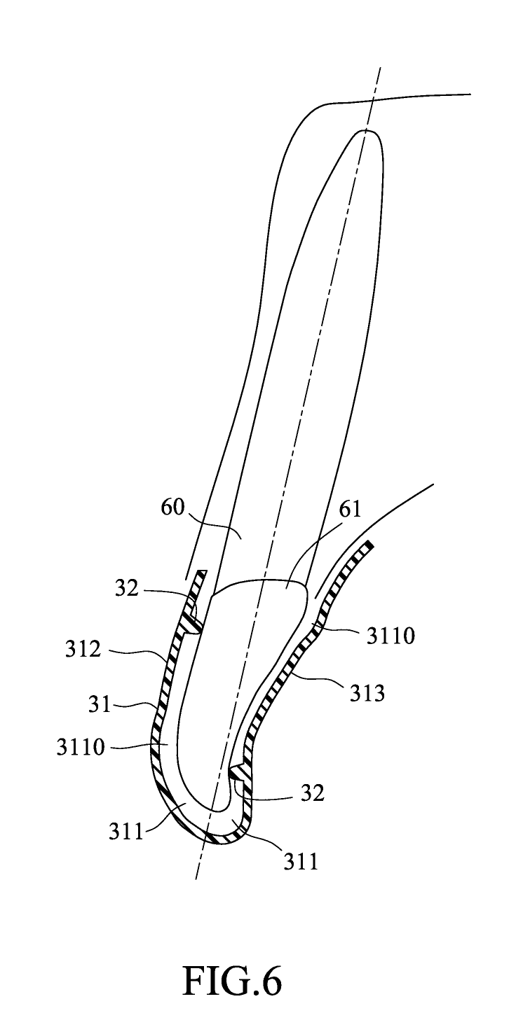

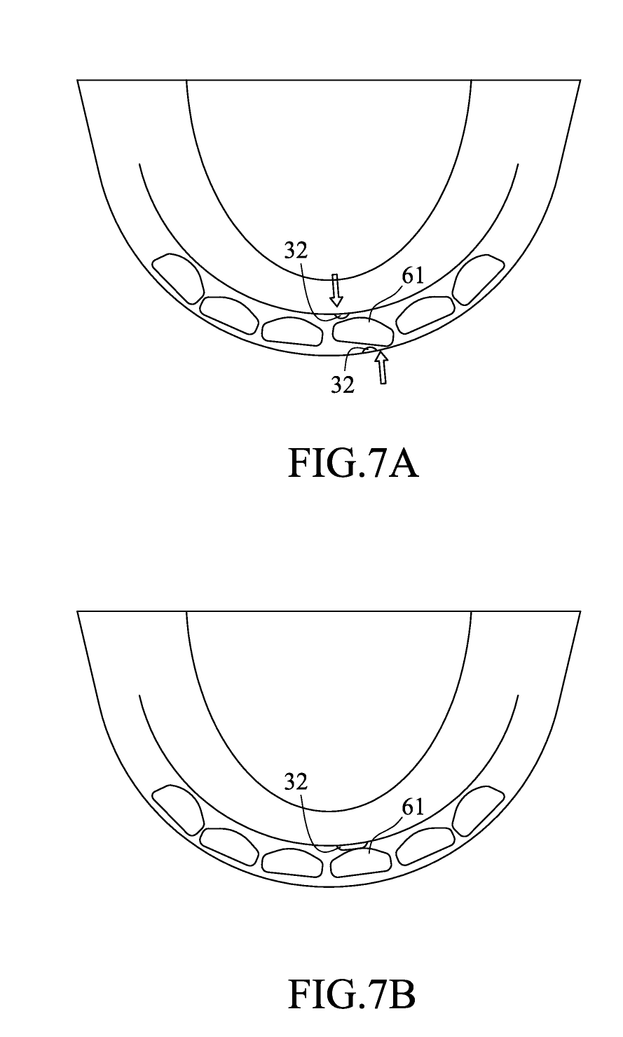

Referring to FIGS. 4 and 5, a first preferred embodiment of the orthodontic system according to the present invention is shown to include a dental appliance 3. The dental appliance 3 is made of a transparent material and includes a main body 31. The main body 31 includes a buccal side wall 312, and a lingual side wall 313 opposite to and cooperating with the buccal side wall 312 to define a receiving space 311 for receiving a tooth 61 of a dentition 6 of a user therein.

The buccal side wall 312 and the lingual side wall 313 define respective reserve rooms 3110 in spatial communication with the receiving space 311 for providing flexibility to the main body 31 so as to accommodate movement of the tooth 61 caused by correcting the tooth 61.

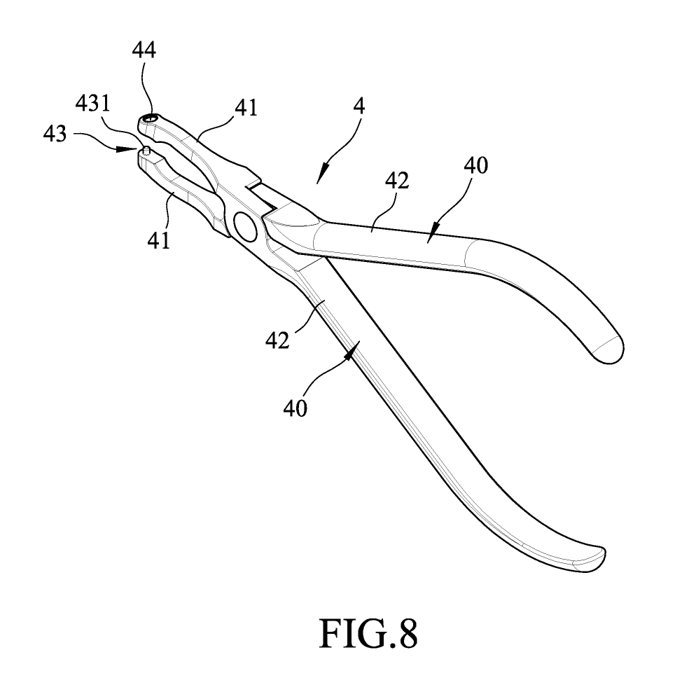

Referring to FIG. 6, in a case that the tooth 61 requires rearrangement by pitching or translating, two protrusions 32 are respectively formed on the buccal side wall 312 and the lingual side wall 313 to facilitate the tooth 61 to move toward a desired position by buccal crown torque. In this embodiment, the protrusions 32 are vertically spaced apart from each other, and protrude into the receiving space 311 for contacting and pushing the tooth 61 in opposite directions respectively away from the protrusions 32. One of the reserve rooms 3110 that is formed on the buccal side wall 312 corresponds to one of the protrusions 32 that is formed on the lingual side wall 313, and the other one of the reserve rooms 3110 that is formed on the lingual side wall 313 corresponds to the other one of the protrusions 32 that is formed on the buccal side wall 312.

One of the protrusions 32 provides a torque to the tooth 61, and the other one of the protrusions 32 provides an opposite torque to the tooth 61 for counteracting rotation of the tooth 61 so as to provide a translational force (indicated by the arrow in FIG. 6) to pitch or translate the tooth 61. By this way, the tooth 61 would not rotate relative to the alveolar bone (not shown) to thereby prevent inclination and prominence of the tooth 61 and a root 60 of the dentition 6.

In another case where the tooth 61 requires pitching or translating in an opposite direction, the protrusions 32 and the reserve rooms 3110 may be otherwise formed in the buccal side wall 312 and the lingual side wall 313, respectively.

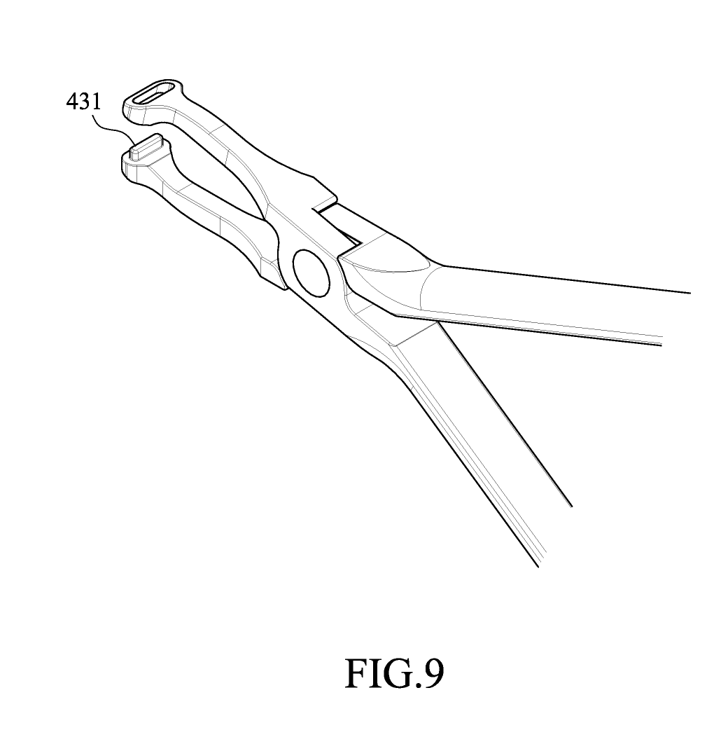

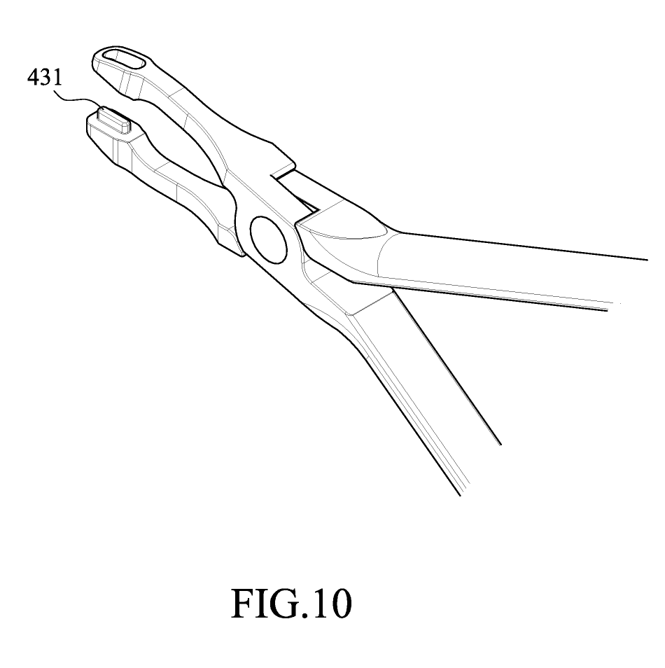

Referring to FIG. 7A, a modification of the protrusions 32 is shown. When the tooth 61 requires rearrangement by torsion force indicated by the arrows in FIG. 7A, the main body 31 of the dental appliance 3 is formed with two protrusions 32 horizontally spaced apart from each other to push the tooth 61 in desired directions. In particular, the protrusions 32 apply forces to the tooth 61 in opposite directions, respectively, so as to yaw the tooth 61. Note that the position of the reserve rooms 3110 are modified to correspond to the respective protrusions 32 accordingly. It should be further noted that, as shown in FIG. 7B, only one protrusion 32 may be formed on the lingual side wall 313 to provide a push force to the tooth 61 according to specific demand of the user.

Although the main body 31 receives the dentition 6 in an upper jaw portion of the user in this embodiment, it may be configured to receive a dentition in a lower jaw portion of the user in other embodiments. The dental appliance 3 further receives a portion of the gums, the palate, and bottom of the mouth therein to provide a relatively good structural strength and increase intensity of rearrangement for the dentition 6. Further, the dental appliance 3 may serve as a container receiving a medicament for particular medicine treatment, such as teeth bleach or periodontal disease for the teeth, while rearrangement of the dentition 6 is being progressed.

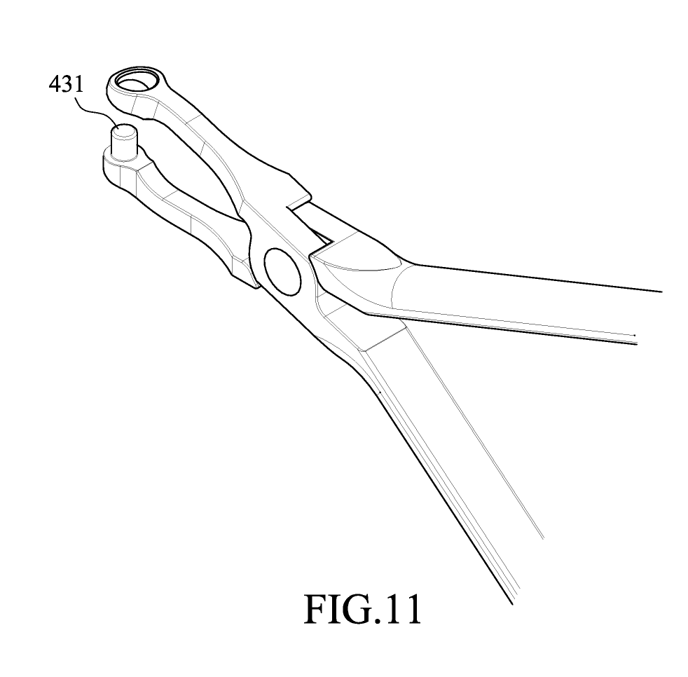

As shown in FIG. 8, the protrusions 32 may be formed by a pliers 4 that includes a pair of hinged arms 40. Each of the hinged arms 40 includes a handle portion 42 and a jaw portion 41 connected to the handle portion 42. The jaw portions 41 of the hinged arms 40 are formed with a male molding member 43 and a female molding member 44, respectively. The male molding member 43 is a projection extending from the jaw portion 41 of one of the hinged arms 40, and has a molding surface 431 for contacting the main body 31 of the dental appliance 3. The female molding member 44 is a through bore engageable and cooperating with the male molding member 43 to form the protrusions 32 on the main body 31 of the dental appliance 3.

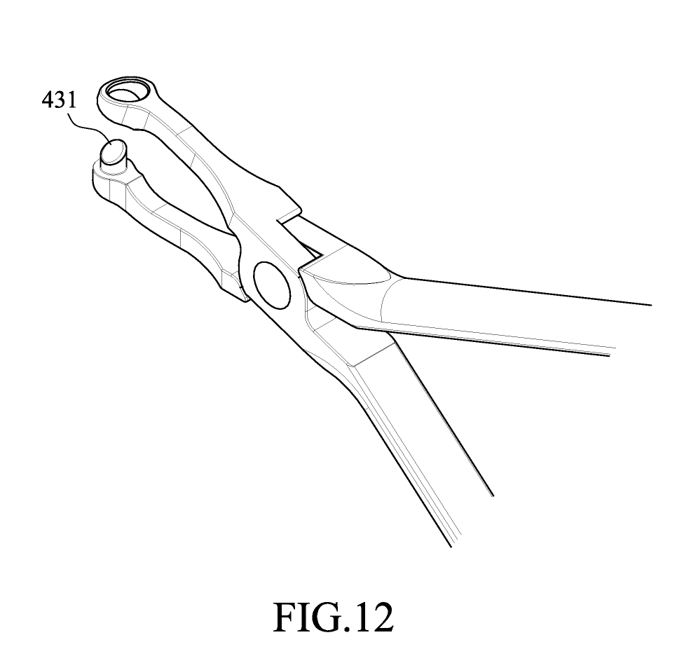

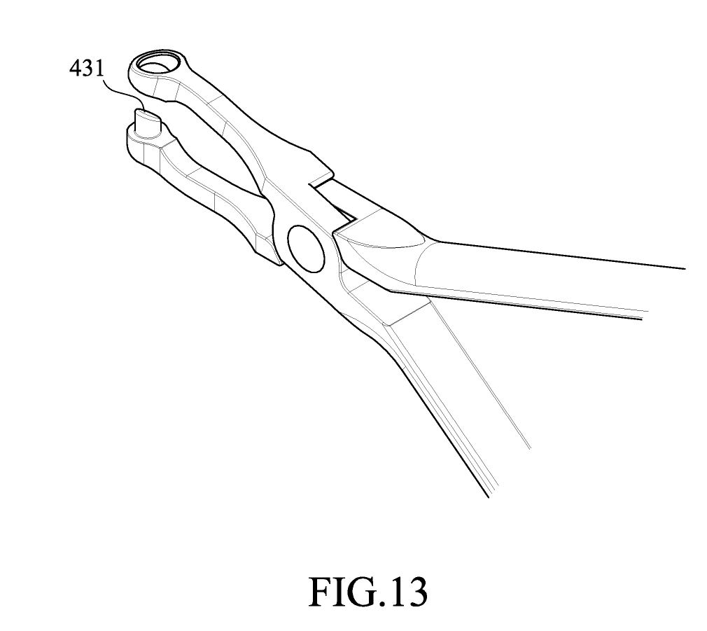

Further referring to FIGS. 9 to 13, the molding surface 431 of the male molding member 43 of the pliers 4 can be configured as a flat surface (FIG. 11), a curved surface (FIGS. 8, 9 and 10), or an inclined surface (FIGS. 12 and 13) for forming protrusions 32′ (see FIG. 14) with different profiles on the main body 31 of the dental appliance 3. Specifically, the male molding member 43 shown in FIG. 9 is configured to form a horizontal strip as one of the protrusions 32 shown in FIG. 6 for translating or pitching the tooth 61. The male molding member 43 shown in FIG. 10 is configured to form a vertical strip as one of the protrusions 32 shown in FIG. 7A for yawing the tooth 61.

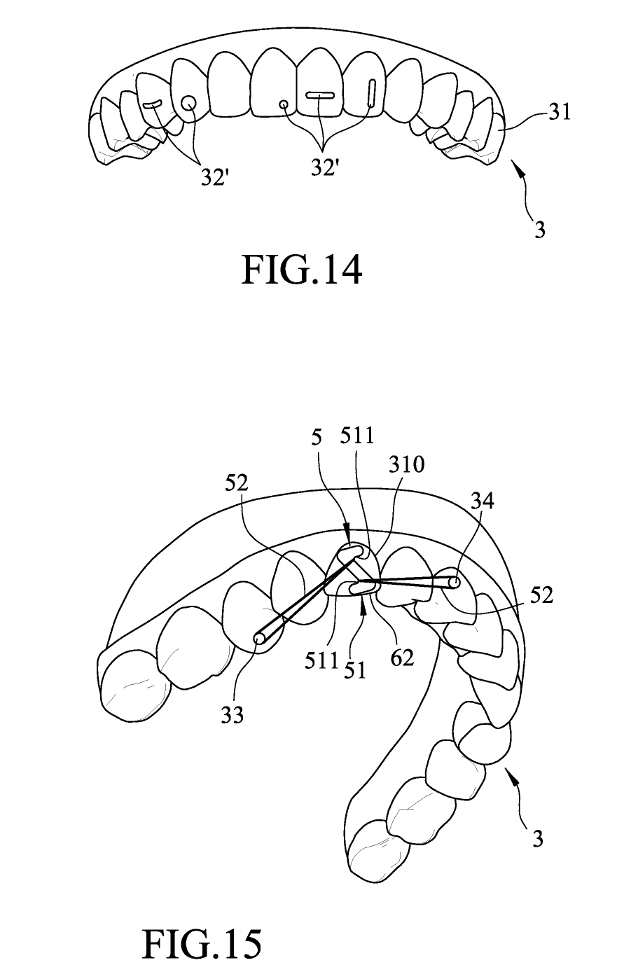

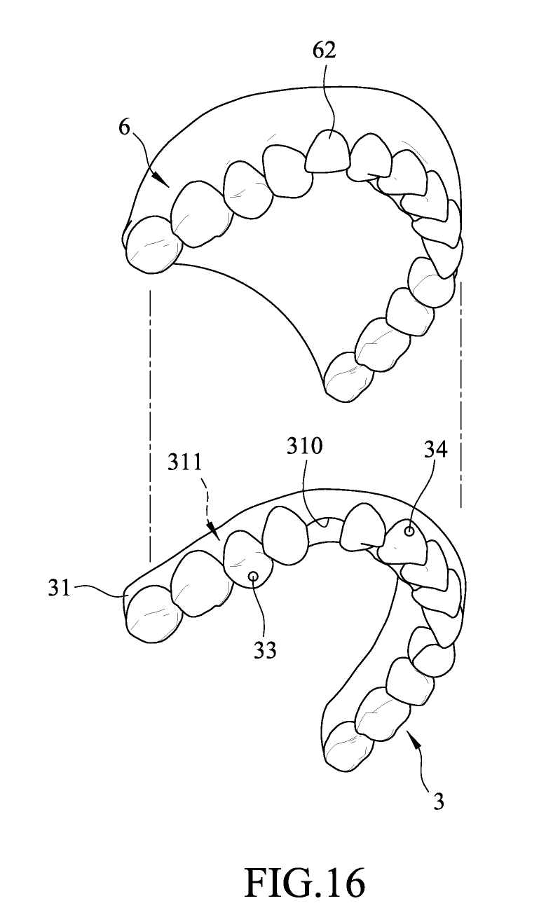

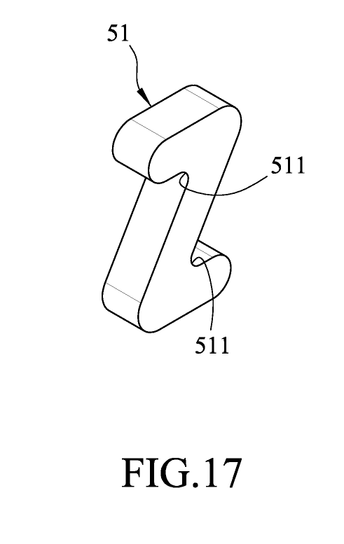

Referring to FIGS. 15 to 17, a second preferred embodiment of the orthodontic system of the present invention is shown. In this embodiment, when incisors of a user extremely project and it is desired to move the incisors by a relatively large translational force, the orthodontic system further includes an auxiliary arrangement unit 5. Since it may be ineffective to correct the extremely projected incisors directly using the dental appliance 3, the auxiliary arrangement unit 5 is used to rearrange and translate a tooth 62 (e.g., a canine) of the user backwardly before using the dental appliance 3 to rearrange the incisors. The main body 31 of the dental appliance 3 is formed with a through hole 310 for permitting extension of the tooth 62 of the dentition 6 of the user, and a main projection 33 and an auxiliary projection 34 flanking the through hole 310 and projecting away from the receiving space 311. Preferably, the main projection 33 and the auxiliary projection 34 are formed by the pliers 4 shown in FIGS. 12 and 13 with the inclined molding surface 431 that forms an inclined column.

The auxiliary arrangement unit 5 includes an attaching member 51 and two restraining members 52. The attaching member 51 is Z-shaped, has two bent portions 511, and is bonded to the tooth 62, which extends through the through hole 310 of the main body 31 of the dental appliance 3. Each of the restraining members 52 interconnects a respective one of the projections 33, 34 and a respective one of the bent portions 511 for providing a translational force to the tooth 62. In this embodiment, the restraining members 52 are elastic bands. Note that a distance between the attaching member 51 and the respective projections 33 may be modified to provide a desired torque.

It should be further noted that the number of the restraining members 52 and the projections 33 may vary according to specific need of the user. For example, when a pulling force rather than a translational force is required, the number of the restraining member 52 and projections 33 may both be one such that the restraining member 52 pulls the tooth 62 toward the projection 33. Further, when a plurality of teeth require rearrangement by translational force, the main body 31 of the dental appliance 3 may be formed with a plurality of through holes 310 that correspond in number to the teeth to be rearranged and that permit the respective teeth to extend therethrough. The number of the attaching members 51 may also be altered depending on the number of teeth to be rearranged by torsion force.

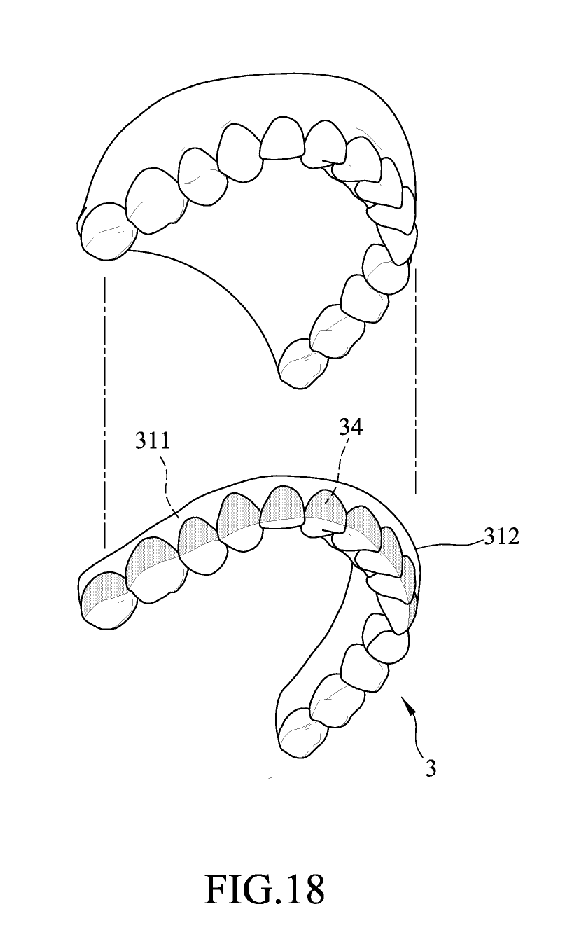

Referring to FIG. 18, a third preferred embodiment of the orthodontic system of the present invention is shown. The dental appliance 3 in this embodiment includes a colored layer 34 attached to the buccal side wall 312 and having a tooth color. When it is desired to conceal the user's teeth color, the colored layer 34 is provided for improving visual appearance of the user's teeth.

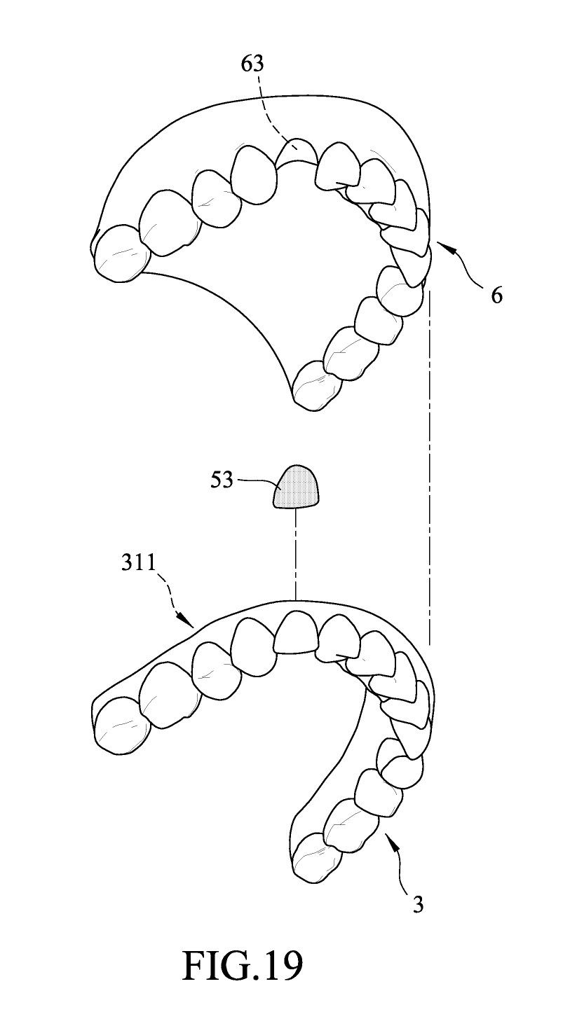

Referring to FIG. 19, a fourth preferred embodiment of the orthodontic system of the present invention is shown. The difference between this embodiment and the first embodiment resides in that the orthodontic system further includes a denture 53 mounted in the receiving space 311 of the dental appliance 3. When the user lacks a tooth and a cavity 63 is formed in the dentition 6, the denture 53 is provided to prevent undesired teeth movement toward the cavity 63 since a dental implant will be processed after orthodontic treatment.

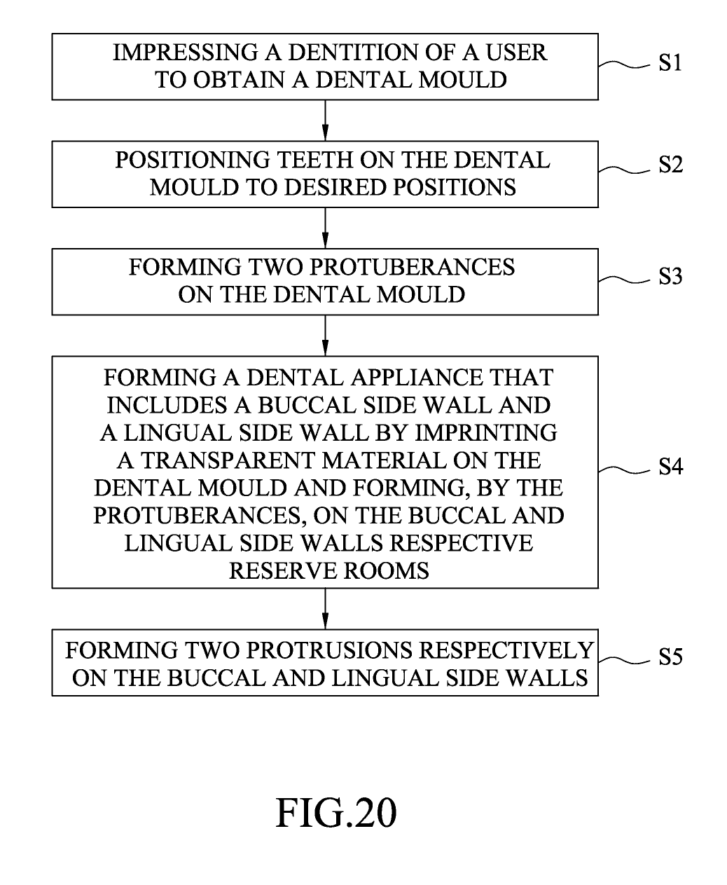

Referring to FIG. 20, a method for manufacturing an orthodontic system includes the following steps. In step S1, a dental mould is obtained by impressing the dentition 6 of a user. In step S2, teeth on the dental mould are positioned to a desired position. In step S3, two protuberances are formed on the dental mould. In step S4, a dental appliance 3 is formed by imprinting a transparent material on the dental mould. The dental appliance 3 includes a main body 31 that is configured to include a buccal side wall 312 and a lingual side wall 313 opposite to and cooperating with the buccal side wall 312 to define a receiving space 311 for receiving the tooth 61 of the dentition 6 of a user therein. The buccal side wall 312 and the lingual side wall 313 are formed with two reserve rooms 3110, which are in spatial communication with the receiving space 311 and are caused by the protuberances, for providing flexibility to the main body 31 so as to accommodate movement of the tooth 61 caused by correcting the tooth 61.

After movement of the tooth 61 toward a predetermined intermediate position, in step S5, two protrusions 32 are formed respectively on the buccal side wall 312 and the lingual side wall 313. The protrusions 32 are formed to protrude into the receiving space 311 to contact and push the tooth 61 in opposite directions respectively away from the protrusions 32 so as to facilitate rearrangement of the tooth 61. One of the reserve rooms 3110 that is formed on the buccal side wall 312 corresponds to one of the protrusions 32 that is formed on the lingual side wall 313, and the other one of the reserve rooms 3110 that is formed on the lingual side wall 313 corresponds to the other one of the protrusions 32 that is formed on the buccal side wall 312.

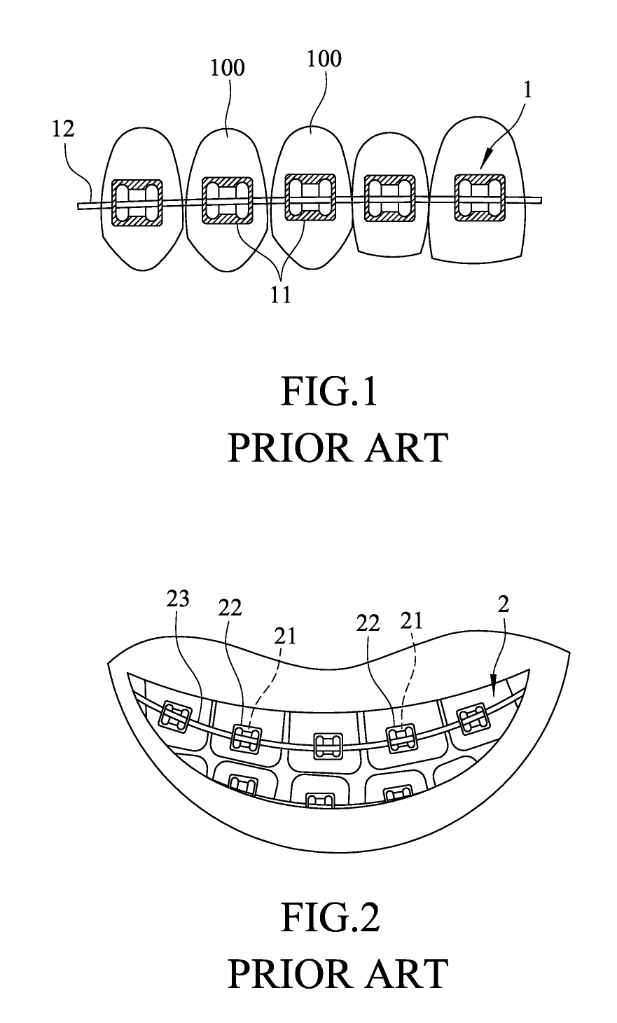

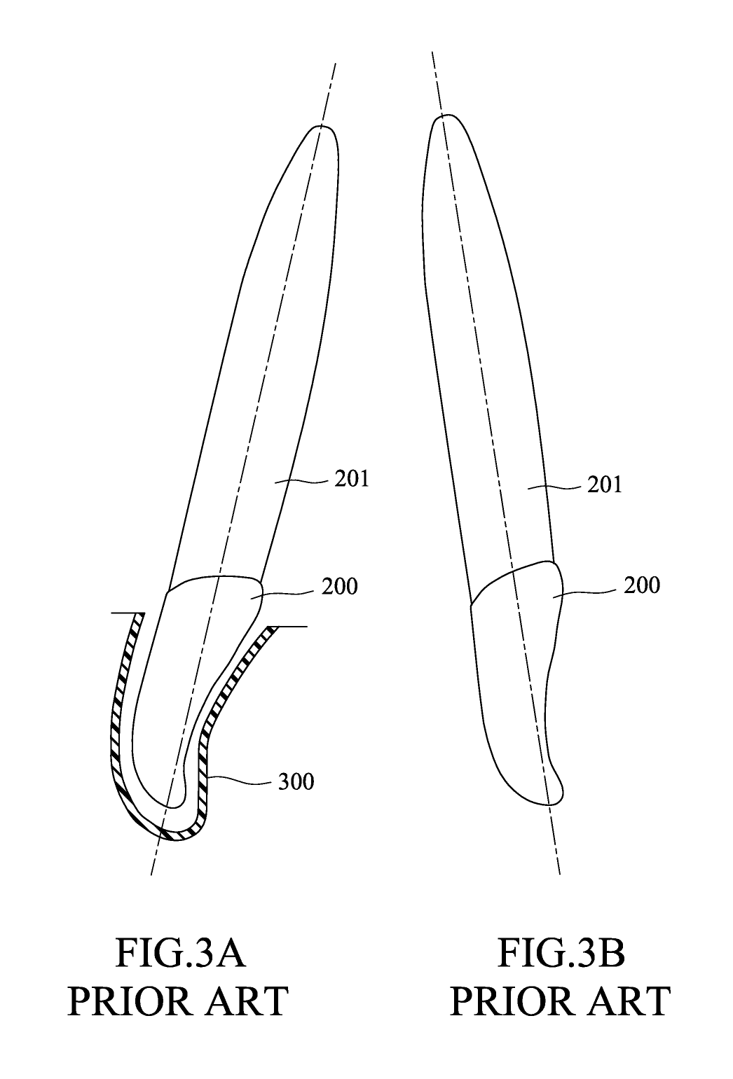

To sum up, the dental appliance 3 made of a transparent material provides a relatively good visual aesthetic quality of the orthodontic system as compared to the conventional dental braces 1, 2 illustrated in FIGS. 1 and 2. Further, by virtue of the reserved rooms 3110 that provide flexibility to the main body 31 and the protrusions 32 having various configuration and providing torques to the tooth 61, the tooth 61 can be corrected properly without causing prominence of the root 60.

While the present invention has been described in connection with what are considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. An orthodontic system comprising:
a dental appliance made of a transparent material and including a main body that includes a buccal side wall and a lingual side wall opposite to and cooperating with said buccal side wall to define a receiving space for receiving at least a portion of a dentition of a user therein, said main body is formed with a main projection projecting outwardly away from said receiving space; and
an auxiliary arrangement unit including an attaching member that is adapted to be bonded to a tooth of the dentition of the user, and at least one restraining member that interconnects said main projection and said attaching member for moving the tooth in a direction toward said main projection.

2. The orthodontic system as claimed in claim 1, wherein said main body of said dental appliance is formed with a through hole adapted for permitting the tooth, to which said attaching member is bonded, to extend therethrough.

3. The orthodontic system as claimed in claim 2, wherein said dental appliance is formed with an auxiliary projection opposite to said main projection with respect to said through hole, and said auxiliary arrangement unit includes two of said restraining members, each of which interconnects a corresponding one of said main and auxiliary projections and said attaching member for translating the tooth toward said main projection.

4. The orthodontic system as claimed in claim 3, wherein said attaching member is Z-shaped and has two bent portions for connection with said restraining members, respectively.

5. The orthodontic system as claimed in claim 1, wherein at least one of said buccal side wall and said lingual side wall define a reserve room in spatial communication with said receiving space for providing flexibility to said main body so as to accommodate movement of a tooth of the dentition of the user caused by correcting the tooth.

6. The orthodontic system as claimed in claims 5, wherein two of said reserve rooms are respectively formed on said buccal side wall and said lingual side wall, and two protrusions are respectively formed on said buccal side wall and said lingual side wall, and protrude into said receiving space for contacting and pushing the tooth in opposite directions respectively away from said protrusions.

7. The orthodontic system as claimed in claim 6, wherein said protrusions are vertically spaced apart from each other (are vertically staggered), one of said reserve rooms that is formed on said buccal side wall corresponds to one of said protrusions that is formed on said lingual side wall, and the other one of said reserve rooms that is formed on said lingual side wall corresponds to the other one of said protrusions that is formed on said buccal side wall.

8. The orthodontic system as claimed in claim 7, wherein one of said protrusions is configured to provide a torque to the tooth, and the other one of said protrusions is configured to provide an opposite torque to the tooth for counteracting rotation of the tooth so as to translate the tooth.

9. The orthodontic system as claimed in claim 7, wherein one of said protrusions is configured to provide a torque to the tooth, and the other one of said protrusions is configured to provide an opposite torque to the tooth for moving and rotating the tooth without causing prominence of a root and the tooth.

10. The orthodontic system as claimed in claim 6, wherein said protrusions are horizontally spaced apart from each other and are configured to yaw the tooth, one of said reserve rooms that is formed on said buccal side wall corresponds to one of said protrusions that is formed on said lingual side wall, and the other one of said reserve rooms that is formed on said lingual side wall corresponds to the other one of said protrusions that is formed on said buccal side wall.

11. The orthodontic system as claimed claim 6, further comprising a pliers including a pair of hinged arms, each of which includes a handle portion and a jaw portion connected to said handle portion, said jaw portion of one of said hinged arms being formed with a male molding member, said jaw portion of the other one of said hinged arms being formed with a female molding member that matches with said male molding member and that is configured to cooperate with said male molding member to form said protrusions and projections on said main body;
said male molding member having a molding surface for contacting said main body of said dental appliance to form said protrusions, said molding surface being in one of a flat surface, a curved surface, and an inclined surface.

12. The orthodontic system as claimed claim 11, wherein said molding member is configured to form one of a vertical strip as one of said protrusions for rotating the tooth, a horizontal strip as one of said protrusions for translating the tooth, and an inclined column as one of said projections.

13. An orthodontic system comprising:
a dental appliance made of a transparent material and including a main body that includes a buccal side wall and a lingual side wall opposite to and cooperating with said buccal side wall to define a receiving space for receiving at least one tooth of a dentition of a user therein;
at least one of said buccal side wall and said lingual side wall define reserve room in spatial communication with said receiving space for providing flexibility to said main body so as to accommodate movement of the tooth caused by correcting the tooth.

14. The orthodontic system as claimed in claims 13, wherein two of said reserve rooms are respectively formed on said buccal side wall and said lingual side wall, and two protrusions are respectively formed on said buccal side wall and said lingual side wall, and protrude into said receiving space for contacting and pushing the tooth in opposite directions respectively away from said protrusions.

15. The orthodontic system as claimed in claim 14, wherein said protrusions are vertically spaced apart from each other (are vertically staggered), one of said reserve rooms that is formed on said buccal side wall corresponds to one of said protrusions that is formed on said lingual side wall, and the other one of said reserve rooms that is formed on said lingual side wall corresponds to the other one of said protrusions that is formed on said buccal side wall.

16. The orthodontic system as claimed in claim 15, wherein one of said protrusions is configured to provide a torque to the tooth, and the other one of said protrusions is configured to provide an opposite torque to the tooth for counteracting rotation of the tooth so as to translate the tooth.

17. The orthodontic system as claimed in claim 15, wherein one of said protrusions is configured to provide a torque to the tooth, and the other one of said protrusions is configured to provide an opposite torque to the tooth for moving and rotating the tooth without causing prominence of a root and the tooth.

18. The orthodontic system as claimed in claim 14, wherein said protrusions are horizontally spaced apart from each other and are configured to yaw the tooth, one of said reserve rooms that is formed on said buccal side wall corresponds to one of said protrusions that is formed on said lingual side wall, and the other one of said reserve rooms that is formed on said lingual side wall corresponds to the other one of said protrusions that is formed on said buccal side wall.

19. A method for manufacturing an orthodontic system, comprising the step of:
impressing a dentition of a user to obtain a dental mould;
positioning at least one tooth on the dental mould to a desired position;
forming at least one protuberance on the dental mould; and
forming a dental appliance by imprinting a transparent material on the dental mould, the dental appliance including a main body that includes a buccal side wall, and a lingual side wall opposite to and cooperating with the buccal side wall to define a receiving space for receiving at least one tooth of the dentition therein, one of the buccal side wall and the lingual side wall being formed with a reserve room, which is caused by the protuberance, in spatial communication with the receiving space for providing flexibility to the main body so as to accommodate movement of the tooth caused by correcting the tooth.

20. The method as claimed in claim 19, further comprising the step of:
forming two of the protuberance on the dental mould and forming two of the reserve rooms respectively one the buccal side wall and the lingual side wall, and after forming the reserve rooms, two protrusions are formed respectively on the buccal side wall and the lingual side wall, and protrude into the receiving space to contact and push the tooth in opposite directions respectively away from the protrusions, one of said reserve rooms that is formed on said buccal side wall corresponding to one of said protrusions that is formed on said lingual side wall, the other one of said reserve rooms that is formed on said lingual side wall corresponding to the other one of said protrusions that is formed on said buccal side wall.
